(19) United States
(12) Patent Application Publication
(10) Pub. No.: US 2025/0217232 A1
(43) Pub. Date: Jul. 3, 2025

(54) APPARATUSES AND METHODS FOR ALIASING IN DEVICE LEVEL ERROR CORRECTION BASED ON MODULE LEVEL ERROR CORRECTION

(71) Applicant: Micron Technology, Inc., Boise, ID (US)

(72) Inventors: Wesley W. Borie, Boise, ID (US); Garth N. Grubb, Boise, ID (US); Dennis G. Montierth, Meridian, ID (US); Matthew D. Jenkinson, Boise, ID (US); Sujeet Ayyapureddi, Boise, ID (US); Michael Schena, Boise, ID (US)

(73) Assignee: Micron Technology, Inc., Boise, ID (US)

(21) Appl. No.: 18/972,361

(22) Filed: Dec. 6, 2024

Related U.S. Application Data
(60) Provisional application No. 63/617,182, filed on Jan. 3, 2024.

(51) Int. Cl. G06F 11/10; G06F 9/30

(52) U.S. Cl. CPC G06F 11/1068; G06F 9/30189; G06F 11/1048

(57) ABSTRACT

A memory module includes a number of memory devices. During a read operation the memory device reads data and parity bits. An error correction circuit of the memory device determines if there is an uncorrectable error in the data and parity bits. If there is an uncorrectable error, the error correction circuit aliases a bit within a specified subset of the data bits. The specified subset may be based on which patterns of errors are correctable by a module level error correction scheme.

### CROSS-REFERENCE TO RELATED APPLICATIONS

This application claims the filing benefit of U.S. Provisional Application No. 63/617,182, filed Jan. 3, 2024. This application is incorporated by reference herein in its entirety and for all purposes.

### BACKGROUND

This disclosure relates generally to semiconductor devices, and more specifically to semiconductor memory devices. In particular, the disclosure relates to volatile memory, such as dynamic random access memory (DRAM). Information may be stored on individual memory cells of the memory as a physical signal (e.g., a charge on a capacitive element). During an access operation, an access command may be received along with address information which specifies which memory cells should be accessed. Multiple memory devices may be packaged together in a module, which is operated by a controller.

In order to preserve the integrity of data stored on the module, error correction may be used. In some embodiments, both the individual memory devices and the controller may separately implement their own error correction schemes. However, some types of errors may not be correctable. There may be a need to expand the types of errors which can be corrected.

### BRIEF DESCRIPTION OF THE DRAWINGS

FIG. 1 is a block diagram of a memory system according to some embodiments of the present disclosure.

FIG. 2 is a block diagram of a semiconductor device according an embodiment of the disclosure.

FIG. 3 is a schematic diagram of an error correction code (ECC) circuit according to some embodiments of the present disclosure.

FIG. 4 is a block diagram of an alias logic circuit according to some embodiments of the present disclosure.

FIG. 5 is a flow chart of a method according to some embodiments of the present disclosure.

FIG. 6 is a flow chart of a method of aliasing bits in a memory device according to some embodiments of the present disclosure.

### DETAILED DESCRIPTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

Memory devices store information in memory arrays. The memory array includes a number of memory cells, organized at the intersection of word lines (rows) and bit lines (columns). Each memory cell may store a bit of information. During an access operation, a row address may be used to specify a word line and a column address may be used to specify one or more bit lines. The information in the memory cells at the intersection of the specified word line and bit lines may be accessed. Memory devices may implement an error correction scheme, for example using an error correction code (ECC) circuit. During a write operation the ECC circuit receives data to be written and generates a set of parity bits based on the data. The data and parity are stored in the memory array. During a read operation, data and parity are read out to the ECC circuit, which uses the read data and parity to locate and correct errors in the data. The corrected data may then be provided off the device.

Memory devices may be packaged together onto a memory module. The memory module may include a number of memory devices, each of which stores data, and one or more error correction memory devices, which may store information used to correct errors when data is read out from the memory. The controller may have its own error correction circuit. During a write operation the controller error correction circuit generates module parity based on the set of data to be written. The set of data is divided up and written to the data memory devices while the module parity is written to the error correction devices. Each of those devices may use their internal ECC circuit to generate parity based on the written portion of the set of data or module parity. During a read operation each data device provides corrects and provides its portion of the data and the error correction devices correct and provide their portion of the module parity. The controller error correction circuit may then use the data and module parity to perform corrections.

In some embodiments, the controller's error correction scheme may not be able to correct all possible errors on a device. For example, certain arrangements of errors throughout the data from a given data device may render the error uncorrectable by the module error correction circuit. As part of certain implementations, these patterns may be arranged based on which bits within the data contain the error. However, the module error correction scheme may be implemented such that there are no uncorrectable patterns of errors which include an error in a certain subset of the bits. In other words, as long as at least one bit within that subset of bits is in error, then the pattern of error bits is one which is correctable by the module error correction. It may be useful to adapt the device ECC scheme to leverage the behavior of the module error correction scheme.

The present disclosure is drawn to apparatuses, systems, and methods for aliasing in device level error correction based on module level error correction. A memory device of the present disclosure may include a module error correction setting. Based on that setting, the device's ECC circuit may alias one of the bits of a specified subset of data bits if the ECC circuit detects an error, but cannot locate that error to one of the plurality of data bits or parity bits (e.g., if the ECC circuit detects an error which is uncorrectable by the device level ECC circuit). The specific subset of data bits may be selected based on the module error correction circuit not having any patterns of uncorrectable errors which include an error in that subset of data bits. By aliasing, the ECC circuit may change a state of one of the specified subset of data bits, even if that bit is not determined to have an error by the device level ECC circuit. In this manner, when the device level ECC circuit cannot correct the error, an error is added in the subset of bits to increase the odds that the error is one that will be correctable by the module level error correction circuit.

In an example memory device, the ECC circuit may include an alias logic circuit which is enabled by a module error correction setting of the memory. The alias logic circuit receives the syndrome from the device's ECC circuit. If the alias logic circuit is disabled, then the syndrome is passed on to a correction circuit which changes a data bit based on the syndrome. If the alias logic circuit is enabled, the syndrome is checked to see if the syndrome has a value which has a non-zero state and which does not indicate one of the data or parity bits. If meets those criteria, then the alias logic circuit may change the syndrome so that it indicates an error in one of the bits within the specified subset of data bits. Based on the changed syndrome, the error correction circuit aliases one of the bits within the specified subset of the data.

In an example implementation, the memory may read a plurality of data bits and their associated parity bits. The ECC circuit may use a logic tree to generate a new set of parity bits from the data, which are compared (e.g., XOR'd) with the read parity bits to locate differences and generate a syndrome. The syndrome may indicate where errors are located in the parity bits. However, the syndrome may have more possible states than there are numbers of data and parity bits (plus a zero value for no errors detected). For example, if there are 128 data bits and 8 parity bits, then the 8 syndrome bits generated from that data and parity has 2\hat{ }8 or 256 unique states. However, those states may normally be used to indicate one of 137 possible error correction locations (128 data bits+8 parity bits+no correction). If the syndrome has one of those states, then the indicated bit may be corrected, or no correction may be performed. However, if the syndrome has one of the remaining 119 states then the error correction circuit may alias one of the specified subset of the data bits. The syndrome may be changed to alias a bit within a specific range of burst bits, on a specific data terminal, or a specified combination thereof.

As used herein, the term data may represent any bits of information that the controller wishes to store and/or retrieve from the memory. The term metadata may represent any bits of information about the data which the controller writes to and/or receives from the memory. For example, the metadata may be information that the controller generates about the data, about how or where the data memory is stored in the memory, about how many errors have been detected in the data, etc. The data and the metadata together represent information written to the memory by a controller and then also read from the memory by the controller, with the data and metadata differing in content and how they are generated in that the metadata is based on information about the data. The term parity may represent any bits generated by an error correction circuit of the memory based on the data, metadata, or combinations thereof. The parity may generally stay within the memory. The term module parity may generally represent any error correction bits generated and used by a module level error correction circuit. In some embodiments, the amount of data, metadata, and/or module parity retrieved as part of a single access operation may represent a set of bits which are a fragment of a larger piece of information. For example, the module parity retrieved from a single device may be combined with module parity from another device before it is useful to correct errors in the data.

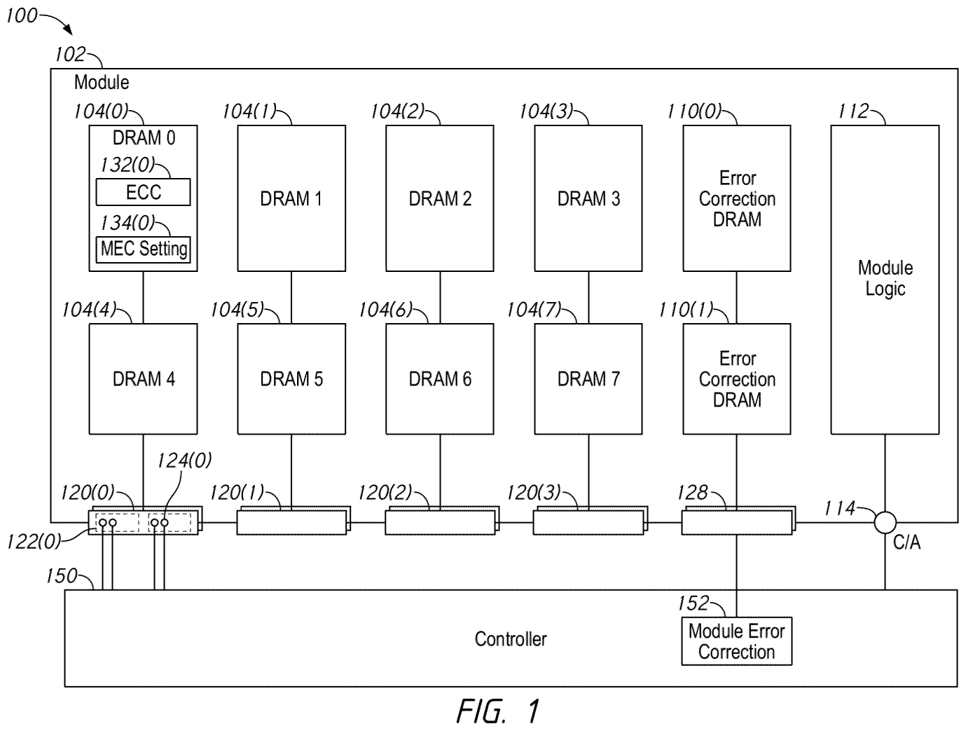

FIG. 1 is a block diagram of a memory system according to some embodiments of the present disclosure. The memory system 100 includes a memory module 102 and a controller 150 which operates the memory module 102. The module includes a number of memory devices 104 and 110. The memory devices 104 may be used to store data and may generally be referred to as data memory devices 104, while the memory devices 110 are used to correct errors in data read from the data memory devices 104. The memory devices 110 may be referred to as an error correction memory devices 110. A module logic 112 receives commands and addresses over a command/address C/A bus from the controller 150 through a C/A terminal 114 and distributes those commands and addresses to the memory devices 104 and 110 over internal command and address buses (not shown). Data is communicated between the controller 150 and the module 102 along data buses which couple to data terminals (DQ) terminals 124 of the module 102. The data terminals 124 are organized into pseudo-channels 122 and channels 120. Each channel 120 is a set of data terminals 124 associated with a memory device 104. A similar set of channels 128 couple the error correction devices 110 to the controller 150.

FIG. 1 shows an example 10×2p2 or 10×4 memory module 102 which may be used to implement some embodiments of the present disclosure. In the 10×4 architecture, there are ten total memory devices 104 and 110. Eight data memory devices 104(0) to 104(7) and two error correction memory devices 110(0) and 110(1). The data memory devices 104 are coupled to the controller through respective channels 120 and the error correction devices 110 are coupled through respective channels 128. Each channel 120(0) to 120(7) and 128(0) to 128(1) includes one or more pseudo-channels 122, which may be operated independently of each other. In this embodiment, each channel 120 or 128 includes two pseudo-channels 122, each of which includes two data terminals 124. Other module architectures may be used in other example embodiments, for example more or fewer data and/or error correction devices may be used, or more or fewer data terminals per pseudo channel. For example, in some embodiments, a x8 module may be used where there are four data terminals per pseudo-channel.

Since the memory devices and channels may generally be similar to each other, only a single device 104(0) and its associate channel 120(0) are described in detail herein. In order to simplify the layout of the figure, an arrangement of two rows of four data devices 104 and one error correction device 110 each is shown, and their associated channels 120 are shown as stacked boxes. However the representation of FIG. 1 does not necessarily represent the layout of a physical device. For example, a single row of 8 data devices 104 and two error correction devices 110 may be used. Similarly, various buses and signal lines have been simplified down to a single line for clarity on the drawing, however, multiple physical signal lines may be represented by a single line in the drawing.

During an example write operation, the controller 150 provides a write command and addresses (e.g., row, column, and/or bank addresses as explained in more detail herein) over the C/A terminal 114 to the module 102. The module logic 112 distributes the command and address to the data memory devices 104(0) to 104(7). The controller 150 also provides data to be written along the various DQ channels 120(0) to 120(7). Since the pseudo-channels 122 may be operated independently, we will consider a single pseudo-channel 122 and its two DQ terminals 124. Each data terminal receives a serial burst of bits, which together represent a codeword of data.

As part of the write operation a module error correction circuit 152 of the controller may generate a set of module parity bits based on the data which is written. For example, the module parity bits may be based off of all of the data written to all of the data devices 104. For example, if each data device 104 receives 64 bits of data, then the module parity bits may be generated based off of the full set of 512 bits of data. The module parity bits may be written to the error correction devices 110 in a fashion analogous to the way the data is written to the data devices 104. When data is written to the data devices 104, and when module parity is written to the error correction devices 110, each device may use an internal ECC circuit to generate parity based off of the written data or module parity.

During an example read operation, the controller 150 provides a read command and addresses along the C/A terminal 114. The module logic 112 distributes these to the memory devices 104 to 110 and data is read out from the locations specified by the addresses in the data devices 104 and module parity is read out from the error correction devices 110. As part of the read operation, each device 104 and 110 also reads out parity which is used by that devices ECC circuit to correct errors in the read data/module parity. The corrected data or module parity is provided to controller 150. The module error correction circuit 152 uses the module parity to perform error correction on the data.

The module error correction circuit 152 may perform error correction based on the amount of module parity bits which are read. In some embodiments, the module error correction circuit 152 may not be capable of correcting every possible pattern of errors in the data from a single one of the devices 104. In some embodiments, whether or not the module error correction circuit 152 can fully correct a device's data may be based on a setting of the controller 150 and module 102. For example, in a first mode, the module error correction circuit 152 may be capable of ‘chipkill’ or correcting up to entire data from a data device 104. In a second mode, the module correction circuit 152 may be less than chipkill. For example, the controller may store metadata on the error correction devices 110. Since this metadata may take up some of the space which would otherwise be used for module parity, fewer bits of module parity may be enabled. Because there is a lower ratio of module parity to data, the module error correction circuit 152 may not implement chipkill when metadata is enabled. Because of this, certain patterns of error may become uncorrectable by the module error correction circuit 152.

To minimize the impact of uncorrectable errors, the module error correction circuit 152 may implement a scheme where certain patterns of error are always correctable. For example, one or more subsets of the bits of data from each device 104 may be identified as particularly important or useful to protect. The module error correction scheme may be organized such that as long as there is at least one error in that subset, the pattern of errors in the data is correctable.

Each data device 104 may have a module error correction setting 134, which identifies a type of module error correction scheme used. For example, the module error correction type setting may identify a type of the controller 150. As explained in more detail herein, based on that setting, if the memory devices 104 ECC circuit 132 detects an error which is not correctable by the ECC circuit 132, then the ECC circuit 132 may alias an additional error into the subset of bits. Since the data from that memory device now includes an error within the subset of bits, the pattern of error bits from that device will not be an uncorrectable one for the module error correction circuit 152, and may thus be repaired by the module error correction circuit 152.

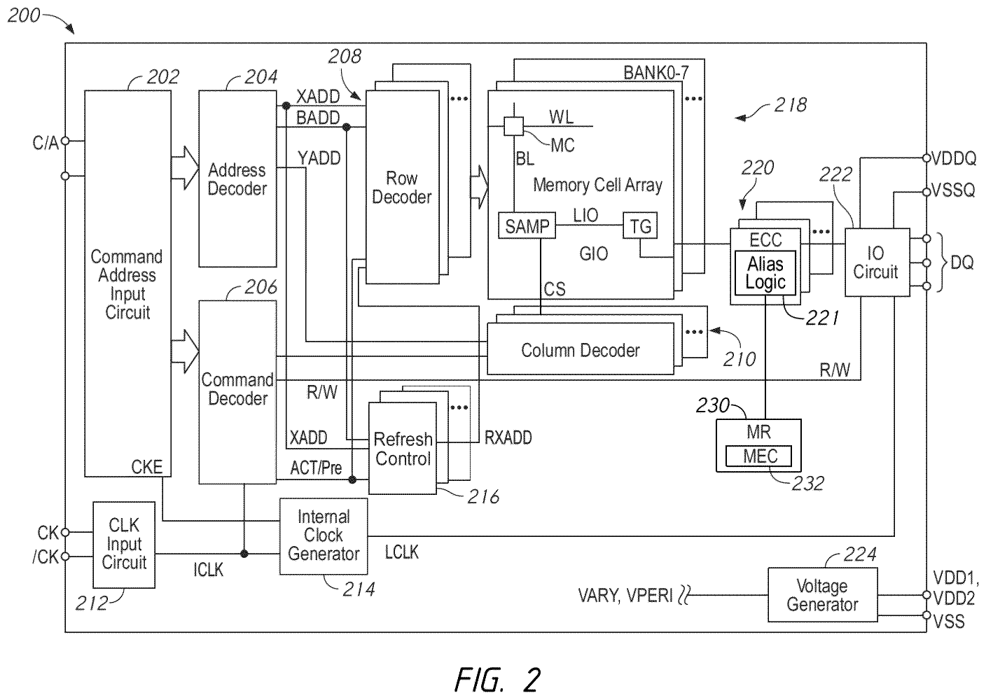

FIG. 2 is a block diagram of a semiconductor device according to an embodiment of the disclosure. The semiconductor device 200 may be a semiconductor memory device, such as a DRAM device integrated on a single semiconductor chip. For example, the device 100 may implement one of the devices 104 of the module 102 of FIG. 1 and/or one of the devices 110 of FIG. 1. For the sake of explanation, the memory device 200 will generally be described with respect to the operations of a data device, such as 104 of FIG. 1, however the error correction devices 110 of FIG. 1 may, in some embodiments, operate in an analogous fashion.

The semiconductor device 200 includes a memory array 218. The memory array 218 is shown as including a plurality of memory banks. In the embodiment of FIG. 2, the memory array 218 is shown as including eight memory banks BANK0-BANK7. More or fewer banks may be included in the memory array 218 of other embodiments.

Each memory bank includes a plurality of word lines WL, a plurality of bit lines BL, and a plurality of memory cells MC arranged at intersections of the plurality of word lines WL and the plurality of bit lines BL. The selection of the word line WL is performed by a row decoder 208 and the selection of the bit lines BL is performed by a column decoder 210. In the embodiment of FIG. 2, the row decoder 208 includes a respective row decoder for each memory bank and the column decoder 210 includes a respective column decoder for each memory bank.

The bit lines BL are coupled to a respective sense amplifier (SAMP). Read data from the bit line BL is amplified by the sense amplifier SAMP, and transferred to an ECC circuit 220 over local data lines (LIO), transfer gate (TG), and global data lines (GIO). Conversely, write data outputted from the ECC circuit 220 is transferred to the sense amplifier SAMP over the complementary main data lines GIO, the transfer gate TG, and the complementary local data lines LIO, and written in the memory cell MC coupled to the bit line BL.

The semiconductor device 200 may employ a plurality of external terminals, such as solder pads, that include command and address (C/A) terminals coupled to a command and address bus to receive commands and addresses, clock terminals to receive clocks CK and /CK, data terminals DQ coupled to a data bus to provide data, and power supply terminals to receive power supply potentials VDD, VSS, VDDQ, and VSSQ. The external terminals may couple directly to the controller (e.g., 150 of FIG. 1) and/or may couple to various buses/connectors of the module (e.g., 102 of FIG. 1).

The clock terminals are supplied with external clocks CK and /CK that are provided to an input circuit 212. The external clocks may be complementary. The input circuit 212 generates an internal clock ICLK based on the CK and /CK clocks. The ICLK clock is provided to the command decoder 206 and to an internal clock generator 214. The internal clock generator 214 provides various internal clocks LCLK based on the ICLK clock. The LCLK clocks may be used for timing operation of various internal circuits. The internal data clocks LCLK are provided to the input/output circuit 222 to time operation of circuits included in the input/output circuit 222, for example, to data receivers to time the receipt of write data. The input/output circuit 222 may include a number of interface connections, each of which may be couplable to one of the DQ pads (e.g., the solder pads which may act as external connections to the device 200).

The C/A terminals may be supplied with memory addresses. The memory addresses supplied to the C/A terminals are transferred, via a command/address input circuit 202, to an address decoder 204. The address decoder 204 receives the address and supplies a decoded row address XADD to the row decoder 208 and supplies a decoded column address YADD to the column decoder 210. The decoded row address XADD may be used to determine which row should be opened, which may cause the data along the bit lines to be read out along the bit lines. The column decoder 210 may provide a column select signal CS, which may be used to determine which sense amplifiers provide data to the LIO. The address decoder 204 may also supply a decoded bank address BADD, which may indicate the bank of the memory array 218 containing the decoded row address XADD and column address YADD.

The C/A terminals may be supplied with commands. Examples of commands include timing commands for controlling the timing of various operations, access commands for accessing the memory, such as read commands for performing read operations and write commands for performing write operations, as well as other commands and operations. The access commands may be associated with one or more row address XADD, column address YADD, and bank address BADD to indicate the memory cell(s) to be accessed.

The commands may be provided as internal command signals to a command decoder 206 via the command/address input circuit 202. The command decoder 206 includes circuits to decode the internal command signals to generate various internal signals and commands for performing operations. For example, the command decoder 206 may provide signals which indicate if data is to be read, written, etc.

The device 200 may receive an access command which is a write command. When the write command is received, and a bank address, a row address and a column address are timely supplied with the write command, write data and metadata supplied to the data terminals DQ by the controller is provided along the data bus and written to memory cells in the memory array 218 corresponding to the row address and column address. The write command is received by the command decoder 206, which provides internal commands so that the write data along is received by data receivers in the input/output circuit 222. The write data is supplied via the input/output circuit 222 to the ECC circuit 220. The ECC circuit generates parity bits based on the received data and the ECC circuit 220 provides the data and parity to the memory array 218 to be written along a word line specified by the row address to memory cells specified by the column address.

The device 200 may receive an access command which is a read command. When a read command is received, and a bank address, a row address and a column address are timely supplied with the read command, read data is read from memory cells in the memory array 218 corresponding to the row address and column address. The read command is received by the command decoder 206, which provides internal commands to activate the row indicated by the row address and couple the columns indicated by the column address through the LIO and GIO to the ECC circuit 220. Data and its associated parity is read out from the memory cells at the intersection of the active word line and selected bit lines to the ECC circuit 220, which checks for errors in the data. The ECC circuit 220 provides the data, which may be corrected or aliased as explained in more detail herein, along the data bus, and the data bits are output to outside from the data terminals DQ via the input/output circuit 222.

In some embodiments, the memory device 200 may operate in an x4 mode or an x8 mode. In an x4 mode, four DQ terminals are used, each of which sends or receives a burst of 16 bits of data for a total of 64 bits. In an x8 mode, eight DQ terminals are used, each of which sends or receives a burst of 16 bits of data for a total of 128 bits. The memory array 218 may generally access information in prefetched codewords of 128 bits (plus 8 bits of parity). This may remain the same across both the x4 and x8 mode. To account for the fewer data bits accessed in the x4 mode, a full codeword may be accessed, and then half of those bits selected to be overwritten (in a write operation) or read out (in a read operation). One or more column plane select bits, which may be part of the column address such as CA10, indicate which portion of the prefetched bits are selected. In a write operation of the x4 mode, the prefetched data and parity may first be read out (and corrected) without aliasing, and then the data may be updated (e.g., by overwriting the half of the data indicated by the column plane select bits), the ECC circuit 220 generates new parity based on that updated data, and then the updated data and parity are written to the array.

The device 200 includes a mode register 230, which stores various information and settings about the memory. The mode register 230 includes a number of storage elements, such as latch circuits, which are organized into registers, each of which stores one or more pieces of information and/or settings. The controller (e.g., 150 of FIG. 1) may perform mode register read operations to read information from specified registers, and may perform mode register write operations to change the information in one or more specified registers. Some registers may be ‘read only’ registers, which can be read by the controller, but which cannot be directly written to by the controller. Some registers may be set on a permanent basis, such that they persist even when the device 200 is powered off. For example, one or more registers of the mode register 230 may be loaded from a set of non-volatile storage elements, such as a fuse array. For example registers which are loaded with settings related to a physical configuration of the device may be loaded from the fuse array since they may generally be expected to be on a permanent basis.

The mode register 230 includes a module error correction (MEC) setting 232. The MEC setting 232 may be used to enable an alias logic circuit 221 of the ECC circuit 220. In some embodiments, the MEC settings 232 may also indicate which subset of the data bits should be aliased. The MEC setting 232 may be set based on the operation of the module error correction circuit (e.g., 152 of FIG. 1). For example, the MEC setting 232 may be set based on a type of controller which the memory device 200 is coupled to. In some embodiments, the controller and/or module may set the MEC setting 232 when the module is coupled to the controller. In some embodiments, the MEC setting 232 may be set when the module is packaged with the controller.

The ECC circuit 220 may detect and/or correct errors in the accessed data. As part of a write operation, the ECC circuit 220 may receive bits from the IO circuit 222 and generate parity bits based on those received bits. The received bits and parity bits are written to the memory array 218. During an example read operation, the ECC circuit 220 receives a set of bits and their associated parity bits from the array 218 and uses them to locate and/or correct errors. For example, in a single error correction (SEC) scheme, up to one bit of error may be located and detected. The ECC circuit 220 may correct the information and then provide the corrected information (and/or a signal indicated detected errors) to the IO circuit 222. The parity bits may generally not be provided to the IO circuit 222.

The ECC circuit 220 includes an alias logic circuit 221, which is enabled or disabled based on the MEC setting 232. If the MEC setting 232 disables the alias logic circuit 221, then the ECC circuit 220 operates as normal, detects and corrects an error, and provides the corrected data to the IO circuit 222. If the ECC circuit 220 enters a state which indicates an uncorrectable error (e.g., a non-zero syndrome that does not point to a valid bit), then the ECC circuit 220 may ignore it and/or provide a signal indicating an error that the device's ECC circuit 220 cannot correct. If the MEC settings 232 enables the alias logic circuit 221, then the ECC circuit 220 may check for errors as normal, however if the ECC circuit 220 determines an uncorrectable error, then instead of ignoring that condition (or providing a signal) the ECC circuit 220 may alias one or more bits in a specified subset of the data bits. In some embodiments, the MEC setting 232 may indicate which subset of bits to alias.

For example, the device 200 may send and receive data as a serial burst of data bits along each of several DQ terminals. In an example implementation, each of four DQ terminals may send/receive a burst of 16 data bits, for a total of 64 bits of data. The selected subset of bits may represent a portion of the serial burst along each of the DQ terminals. For example, the bits may be divided into four burst bit (BB) portions of four burst bits along each of the four DQ terminals, for example BB[0:3] represents the first four bits streamed in series across four DQ terminals, or 16 total bits out of the 64 bits of data. The alias logic circuit 221 may alias one (or more) of the bits of a specific BB portion. The specified BB portion may be one in which the module level error correction circuit has no uncorrectable error patterns as long as at least one error is located in that BB portion. In another example, the alias logic circuit may alias one (or more) of the bits along a specified DQ terminal or terminals, based on a module level error correction scheme which has no uncorrectable error patterns which include errors along that DQ terminal. In some embodiments, both a burst bit (or range of burst bits) and a terminal (or terminals) based on the behavior of the module level error correction circuit. In this manner, the MEC setting 232 and alias logic 221 may operate independently of the module error correction circuit, but may be used to set the data into a state which is advantageous for correction by the module error correction circuit.

The device 200 includes refresh control circuits 216 each associated with a bank of the memory array 218. Each refresh control circuit 216 may determine when to perform a refresh operation on the associated bank. The refresh control circuit 216 provides a refresh address RXADD (along with one or more refresh signals, not shown in FIG. 1). The row decoder 208 performs a refresh operation on one or more word lines associated with RXADD. The refresh control circuit 216 may perform multiple types of refresh operation, which may determine how the address RXADD is generated, as well as other details such as how many word lines are associated with the address RXADD.

The power supply terminals are supplied with power supply potentials VDD and VSS. The power supply potentials VDD and VSS are supplied to an internal voltage generator circuit 224. The internal voltage generator circuit 224 generates various internal potentials VARY, and the like based on the power supply potentials VDD and VSS supplied to the power supply terminals.

The power supply terminals are also supplied with power supply potentials VDDQ and VSSQ. The power supply potentials VDDQ and VSSQ are supplied to the input/output circuit 222. The power supply potentials VDDQ and VSSQ supplied to the power supply terminals may be the same potentials as the power supply potentials VDD and VSS supplied to the power supply terminals in an embodiment of the disclosure. The power supply potentials VDDQ and VSSQ supplied to the power supply terminals may be different potentials from the power supply potentials VDD and VSS supplied to the power supply terminals in another embodiment of the disclosure. The power supply potentials VDDQ and VSSQ supplied to the power supply terminals are used for the input/output circuit 122 so that power supply noise generated by the input/output circuit 122 does not propagate to the other circuit blocks.

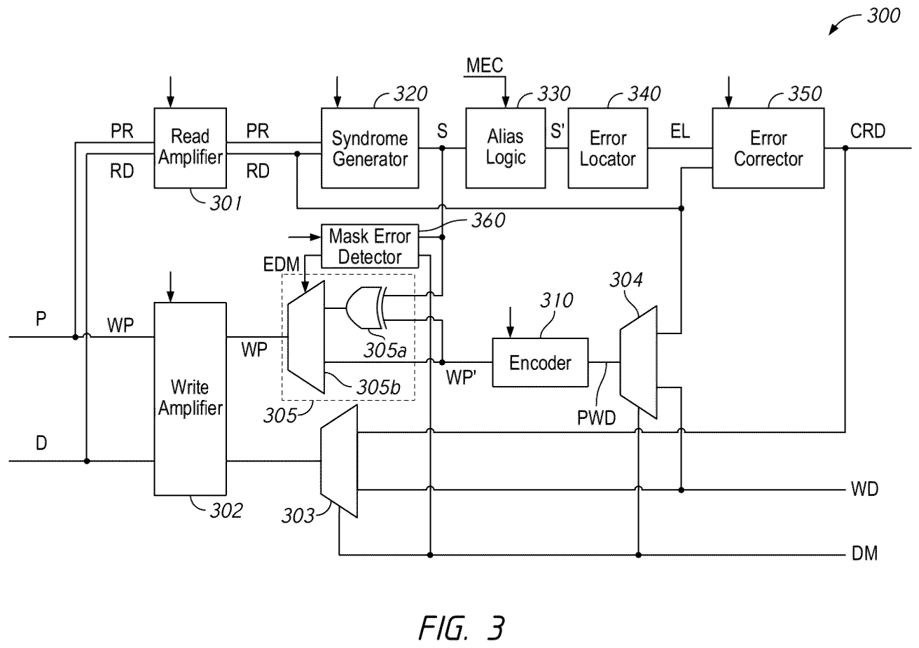

FIG. 3 is a schematic diagram of an error correction code (ECC) circuit according to some embodiments of the present disclosure. The ECC circuit 300 of FIG. 3 may, in some embodiments, implement the ECC circuit 220 of FIG. 2. The ECC circuit 300 receives write data bits WD and generate written parity bits WP as part of a write operation. These may be provided to the memory array as data bits D and parity bits P to be written. The ECC circuit 300 receives data D from the memory array as read data RD and parity bits P as read parity bits PR as part of a read operation generates corrected data bits CRD based on the bits RD and PR.

The example ECC circuit 300 of FIG. 3 may be used for data mask operations. In a data mask write operation, data is read out from the memory array and corrected to form corrected data CRD, and then only a portion of that data is overwritten with new write data bits WD. A data mask signal DM indicates which bits are being overwritten with new write data WD and which bits are remaining as the corrected data CRD. In other example implementations, data masking may not be used, and components related to the masking such as the multiplexers 303, 304, and 305 may be omitted.

In an example write operation to the memory device, the ECC circuit 300 receives write data WD and a data mask signal DM. Before the write operation is performed, a set of data D and its respective parity P is read out as read data and parity PR and RD, and corrected data CRD is generated (as described in more detail below). A first multiplexer 303 may synthesize the write data WD and the corrected read data CRD based on the data mask signal DM, for example by replacing certain bits of the corrected read data CRD with the write data WD as indicated by DM. The first multiplexer 303 may provide the data D, which is written to the memory array. In some embodiments, the data mask signals DM may be associated with the different burst bits received at the data terminals. When one (or more) of the data mask bits DM is active, then the write data WD associated with that data mask bit may be replaced by the corrected read data CRD in the data D.

A second multiplexer 304 may synthesize the write data WD and the read data RD based on the data mask signal. The second multiplexer 304 may provide parity write data PWD. The parity write data PWD may be provided to an encoder circuit 310, which may encode the parity data PWD into the write parities WP′. The encoder circuit 310 may include a logic tree. The write parities WP′ are provided to a converter circuit 305 which generates the write parities WP, which are written to the memory array as the parity bits P.

The converter circuit 305 includes an XOR logic gate 305a and a third multiplexer 305b. The XOR logic gate 305a has input terminals coupled to the syndrome bits S and the write parity bits WP′. The XOR logic gate 305a provides an output which is at a high logical level when the syndrome bite S is different from the associated write parity bit WP′. The third multiplexer 305b provides either the output of the XOR logic gate 605a or the write parity WP′ as the write parity WP. The multiplexer 305b choses the source of the write parity WP bits based on a conversion signal EDM. When the conversion signal EDM is active, the write parity WP is the output of the XOR gate 305a. When the conversion signal EDM is inactive, the signal WP′ is provided as the signal WP. The write parity WP and the write data WD may be provided to a write amplifier 602, which may provide them as the parity P and data D to be written to the memory array.

A mask error detector circuit 360 provides the signal EDM based on the syndrome bits S and on the data mask DM. The mask error detector circuit 360 may determine whether or not burst data to which an error bit belongs and burst data masked by the data mask signal DM are coincident. If they are coincident, then the signal EDM may be activated. If they are not coincident, the signal EDM may remain inactive.

During an example read operation, the read amplifier 301 is activated to amplify the data and parity from the array D and P as read parity bits PR and read data RD. The amplified bits PR and RD are provided to a syndrome generator circuit 320. The syndrome generator 320 provides syndrome bits S based on the read bits RD and PR. The syndrome generator includes a logic tree, which combines the read data bits RD and read parity bits RP to generate the syndrome bits S. The syndrome generator circuit 320 includes a tree of logic gates which may match the logic tree which of the encoder circuit 310 which is used to generate write parity. The logic tree may be a number of gates, such as XOR gates, which combine different bits of the read data to generate a bit in a manner analogous to how the parity was generated. This new parity is then compared to the read parity RP (e.g., by XORing the new parity and the read parity) to determine if there are differences. The syndrome S may be a set of bits (e.g., the same number of bits as the parity) which indicates a difference between the state of the bits which were written (e.g., the bits used to generate the parity) and the state of the bits which were read RD.

The state of the syndrome may indicate where the error is located. For example, if there are 8 syndrome bits (and 8 parity bits), then the syndrome has 256 possible different states. However, there may be less than 256 data and parity bits. Accordingly, some syndrome states may be used to indicate errors in a particular data bit or parity bit, while other syndrome states are normally unallocated. For example, if there are 128 data bits prefetched as part of a read operations (64 of which are provided to the controller) then 128 syndrome states are used for data bits, 8 are used for parity bits, and 1 is used to indicate no errors (e.g., no difference between the new and read parity). For example, if the syndrome S has a value of 0, then it may indicate no errors.

The syndrome bits S are provided to an alias logic circuit 330, which determines whether or not to alter the syndrome S to generate updated syndrome bits S′. If an MEC setting is disabled, then the alias logic circuit 330 provides the syndrome bits S as the updated syndrome bits S′ without making any changes. If the MEC setting is enabled, then the alias logic circuit 330 may check the state of the syndrome bits S to determine whether or not to change the syndrome. If the syndrome has a zero state (no errors detected) then the syndrome S may be passed as S′. If the syndrome has a state which is mapped to an error in one of the data or parity bits RD and RP, then the syndrome S may be passed as S′. If the syndrome S has a non-zero state which does not map to one of the data or parity bits, then the alias logic circuit 330 may alter the syndrome S to generate S′. For example, the syndrome S may be altered so that it has a state which indicates an error in one of the specified subset of bits (e.g., within a specified set of burst bits, specified set of DQ terminals, or combination thereof).

The alias logic circuit 330 provides the updated syndrome S′ to an error locator circuit 340. The error locator circuit 340 decodes the value of S′ to determine which bit of the data should be changed (if any). The error locator circuit 340 provides an error location signal EL based on the decoded syndrome S′. For example, a subset of the syndrome bits S′ may be used to indicate a DQ terminal and another subset may be used to determine which bit in the burst of bits along that DQ terminal should be changed.

An error corrector circuit 350 changes the state of the bit indicated by EL. The error corrector circuit 350 may invert a state of the bit in the read data RD which is indicated by the EL signal to generate the corrected read data CRD. All or a part of the corrected read data is provided to the IO circuit to be provided off the device. In an example x8 mode, all 128 bits may be provided off of the device. In an example x4 mode there may be 128 corrected data bits CRD, 64 of which are provided to the controller. A column plane select bit of the column address may be used to determine which portion of the corrected data bits to provide. In an example embodiment, during x4 mode, the alias logic circuit 330 may alias one of the bits which is in the portion selected by the column plane select bit. Accordingly, the alias logic circuit 330 may receive the column plane select bit and determine which bit to alias based, in part, on the column plane select bit. In this manner the aliased bit may be in the portion of the corrected bits CRD which are provided to the controller.

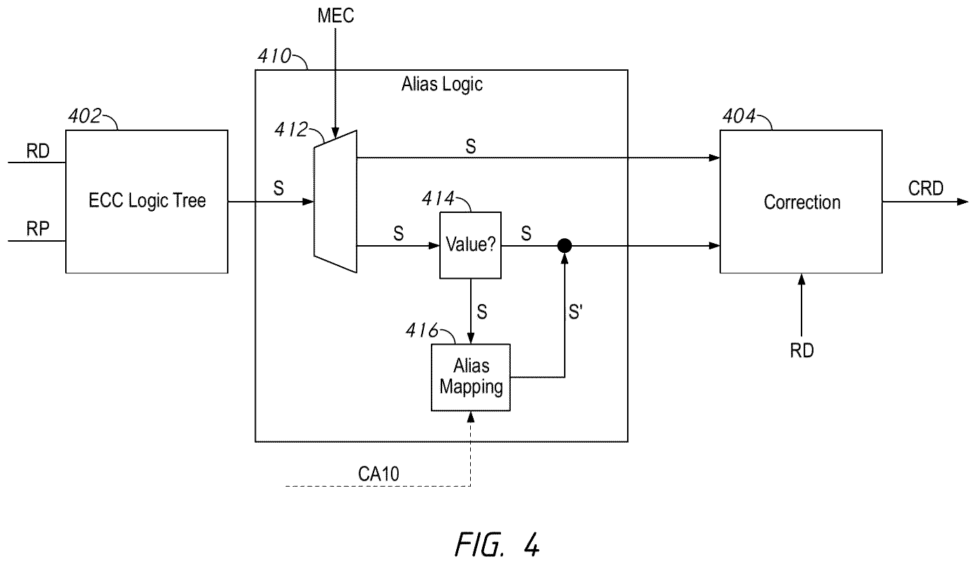

FIG. 4 is a block diagram of an alias logic circuit according to some embodiments of the present disclosure. The alias logic circuit 310 may, in some embodiments, implement the alias logic circuit 221 of FIG. 1 and/or 330 of FIG. 3. Also shown in FIG. 3 are an ECC logic tree 302 (e.g., the syndrome generator 320 of FIG. 3) and an error correction circuit 304, which may include the error locator circuit 340 and error corrector circuit 350 of FIG. 3.

The logic tree 402 generates a set of syndrome bits S based on the read data RD and read parity RP read from the memory array. The logic tree 402 combines the bits of the read data to generate new parity, which is combined with the read parity RP (e.g., by XORing) to generate the syndrome bits S. For example, 128 data bits and 8 parity bits may be read out (in either the x8 or x4), and the logic tree 402 may generate 8 syndrome bits. The state of the syndrome bits S indicates if an error was detected, and if it is located in one of the data bits and parity bits, or if it cannot be located (e.g., because there are multiple bits in error).

The alias logic circuit 401 receives the syndrome bits and either passes the syndrome bits S or modifies the syndrome bits to generate updated syndrome bits S′, depending on an MEC setting (e.g., 232 of FIG. 2) and the value of the syndrome bits S. If the MEC setting is enabled, and if the syndrome bits S indicate an error which cannot be located, then the syndrome bits S are updated to alias one of the data bits. Otherwise (e.g., MEC is not enabled, there are no errors or the error is locatable) then the alias logic circuit 410 passes the syndrome bits as-is.

The correction circuit 404 corrects the read data RD to generate corrected data CRD based on a state of the syndrome bits S or S′. The correction circuit 404 may determine a location of the error based on the state of the syndrome bits S or S′ and change a state of the bit indicated by the syndrome. If the syndrome bits indicate there is no error (e.g., have a zero state) then the read data bits are passed as the corrected data CRD. When the alias logic is disabled (e.g., MEC is inactive) the syndrome bits S will indicate either no error, an error in one of the data or parity bits, or an uncorrectable error. When the alias logic is enabled, the syndrome bits S′ will either indicate no error or an error in one of the data or parity bits.

The alias logic circuit 410 includes a multiplexer 412, which receives the syndrome bits as an input, and either provides the syndrome bits S to the correction circuit 404 or to a syndrome value checker circuit 414. The multiplexer 412 provides the syndrome bits based on a state of the MEC setting. If the MEC setting disables the alias logic circuit 410, then the multiplexer 412 provides the syndrome bits S from the logic tee 402 to the correction circuit 404. If the MEC setting enables the alias logic circuit 410, then the multiplexer 412 provides the syndrome bits S from the logic tree 402 to the value checker circuit 414.

The value checker circuit 414 determines if the syndrome bits have a non-zero value which does not map to one of the data bits or parity bits. If the value of the syndrome bits S indicates no error (e.g., a zero state) then the syndrome bits are provided as-is to the correction circuit 404. If the value of the syndrome bits S maps to one of the data bits or parity bits, then the syndrome bits are provided as-is to the correction circuit 404. If those conditions are not met, the syndrome bits are provided to an alias mapping circuit 416.

The alias mapping circuit 416 receives the syndrome bits S and provides updated syndrome bits S′. The alias mapping circuit 416 alters the states of one or more of the syndrome bits S to generate the updated bits S′. The syndrome bits are updated such that the updated syndrome bits S′ indicate an error within a specific subset of the data bits. For example the updated syndrome bits S′ may indicate an error within a specific burst bit. In some embodiments, the alias mapping circuit 416 may receive a setting such as MEC which tells it which bits should be aliased. In some embodiments, the value mapping circuit 416 may receive a column plane select bit such as CA10, and alter the value of the syndrome such that the bit is aliased in the specific subset and also in the portion of the corrected bits which is selected by the state of the column plane select bit.

In some embodiments, a specific subset of the syndrome bits may be checked and altered by the value checker 414 and alias mapping circuit 416 respectively. For example a first subset such as S[3:0] may be used to determine a burst bit location, while a second subset such as S[7:4] may determine a DQ terminal. Accordingly the alias mapping circuit 416 may check and alter the first subset, since that will determine in which burst bit the syndrome determines an error. In some embodiments, the value checking circuit 414 and alias mapping circuit 416 may be implemented with XOR logic gates, based on known patterns of how the subsets of syndrome bits should operate when the syndrome bits do and do not indicate an error within the data and parity bits.

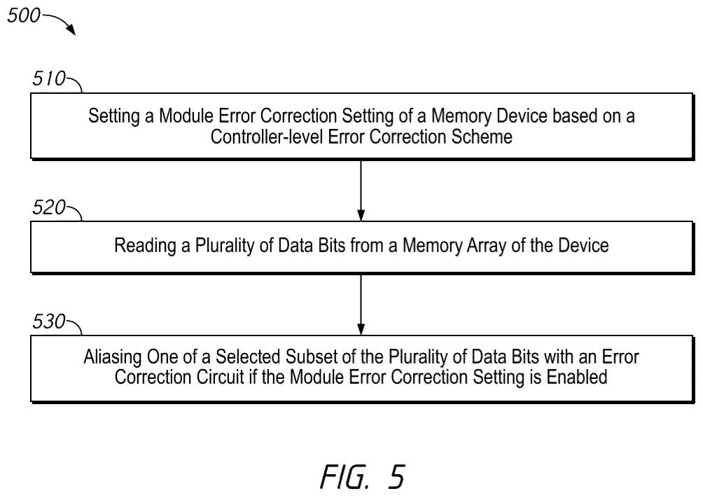

FIG. 5 is a flow chart of a method according to some embodiments of the present disclosure. The method 500 may, in some embodiments, be implemented by one or more of the apparatuses and systems described herein. For example, the method 500 may be implemented by the memory system 100 of FIG. 1, and/or by one or more of the memory devices 104/110 of FIG. 1 and/or 200 of FIG. 2.

The method 500 may begin with box 510, which describes setting a module error correction (MEC) setting of a memory device based on a controller-level error correction scheme. The MEC setting (e.g., 134 of FIG. 1 and/or 232 of FIG. 2) may be stored in a mode register. The MEC setting may be based on a scheme implemented by a module error correction circuit such as 152 of FIG. 1. In some embodiments, the method 500 may include setting the MEC setting based on a type or manufacturer of a controller (e.g., 150 of FIG. 1) coupled to the memory device. In some embodiments, method may include enabling or disabling an alias logic circuit (e.g., 221 of FIG. 2, 330 of FIG. 3, and/or 410 of FIG. 4) based on the MEC setting. In some embodiments, the method 500 may include selecting a subset of bits based on the MEC setting.

Box 510 is followed by box 520, which describes reading a plurality of data bits from a memory array of the device. For example, the memory device may receive a read command, row, column, and bank address as part of a read operation. The method 500 may include reading a plurality of parity bits along with the plurality of data bits.

Box 520 is followed by box 530, which describes aliasing one of a selected subset of the plurality of data bits with an error correction circuit if the module error correction setting is enabled. Box 530 may include determining if there is an uncorrectable error with the error correction circuit (e.g., 132 of FIG. 1, 220 of FIG. 2, and/or 300 of FIG. 3). For example the method 500 may include generating a plurality of syndrome bits from the data and parity bits and determining an uncorrectable error if the plurality of syndrome bits has a non-zero state which is not associated with one of the plurality of data bits and the plurality of parity bits. The aliasing may include altering the syndrome so that it indicates an error in the one of the selected subset of data bits. For example the selected subset may represent a specified range of burst bits, a specified DQ terminal, or combinations thereof. In some embodiments the method 500 may include changing a portion of the syndrome which indicates the specified portion of the data which will be aliased, but not another portion of the syndrome. For example, if the method includes aliasing a specified range of burst bits, the method may include changing a portion of the syndrome which indicates a burst bit but not changing a portion which indicates a data terminal. For example, the method may involve changing S[0:3] but not S[4:7]. In some embodiments, the method 500 may include selecting a portion of the plurality of data bits based on a column plane select bit (e.g., as part of an x4 mode) and aliasing a bit within the selected subset which is also within the portion selected by the column plane select bit.

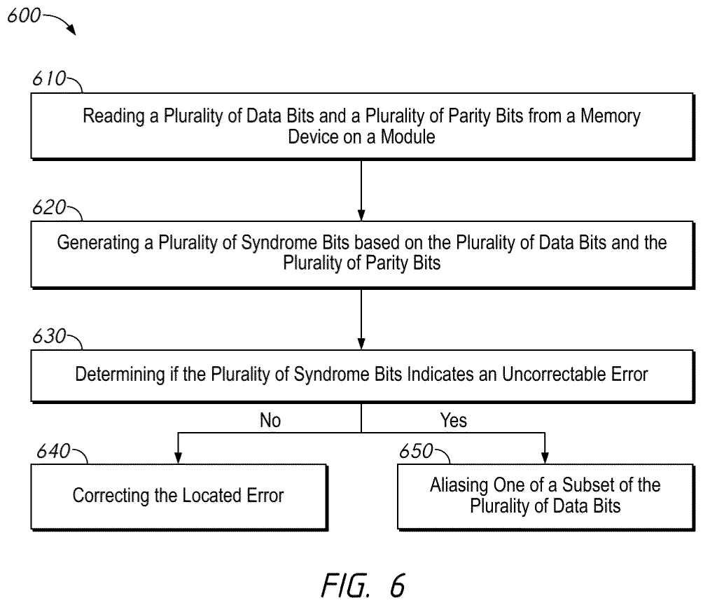

FIG. 6 is a flow chart of a method of aliasing bits in a memory device according to some embodiments of the present disclosure. The method 600 may, in some embodiments, be implemented by one or more of the apparatuses and systems described herein. For example, the method 600 may be implemented by the memory system 100 of FIG. 1, and/or by one or more of the memory devices 104/110 of FIG. 1 and/or 200 of FIG. 2. In some embodiments, the steps of the method 600 may implement a portion of the method 500 of FIG. 5. For example box 610 may implement box 520 of FIG. 5, and boxes 620-650 may implement box 530 of FIG. 5 in some embodiments.

The method 600 may begin with box 610, which describes reading a plurality of data bits and a plurality of parity bits from a memory device on a module. For example the data bits and parity bits may be read from a memory array of the memory device as part of a read operation.

Box 610 may be followed by box 620, which describes generating a plurality of syndrome bits based on the plurality of data bits and parity bits. For example with a logic tree or syndrome generator (e.g., 320 of FIG. 3 and/or 402 of FIG. 4). The method 600 may include generating new parity bits based on the plurality of data bits and combining the new parity bits with the plurality of parity bits to generate the plurality of syndrome bits.

Box 620 may be followed by box 630 which describes determining if the plurality of syndrome bits indicates an uncorrectable error. For example, the method may include determining if the plurality of syndrome bits has a state which indicates no error or at least one error (e.g., a non-zero state). If the syndrome bits indicate at least one error, the method may include determining if the error is located in one of the plurality of data or parity bits or not. If there is a non-zero state where the error is not located in one of the data or parity bits it indicates an uncorrectable error. If there is no error, the method 600 may include providing the plurality of data bits (unchanged) to DQ terminals of the memory device.

If there is an error, then if the error is correctable (e.g., locatable) the method 600 may proceed to box 640, which describes correcting the located error. For example, the method 600 may include changing a state of the bit indicated by the syndrome. If the error is not correctable, the method 600 may proceed to box 650.

Box 650 describes aliasing one of a subset of the plurality of data bits if there is an error which is uncorrectable (by the ECC circuit). In some embodiments, the method 650 may include enabling or disabling the aliasing of box 650 based on a module error correction setting. The module error correction setting may be set based on an error correction scheme of a module error correction circuit (e.g., 152 of FIG. 1).

The method 600 may include aliasing a bit in a specified range of burst bits, a specified subset of DQ terminals, or a combination thereof. The method 600 may include changing the plurality of syndrome bits if the plurality of syndrome bits indicates an uncorrectable error and aliasing the one of the subset of the plurality of data with an error correction circuit based on the changed plurality of syndrome bits. The method 600 may include changing a portion of the plurality of syndrome bits which indicates a burst bit location.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. An apparatus comprising:
a memory array configured to store a plurality of data bits and a plurality of parity bits;
a mode register configured to store a module error correction setting;
an error correction code (ECC) circuit configured to determine if there is a correctable error in the plurality of data bits and parity bits and configured to alias one of a subset of the plurality of data bits if the module error correction setting is enabled.

2. The apparatus of claim 1, wherein the module error correction setting is set based on a type of a controller coupled to the apparatus.

3. The apparatus of claim 1, wherein the subset of the plurality of data bits is a specified range of burst bits, a specified data terminal, or combinations thereof.

4. The apparatus of claim 1, wherein the ECC circuit is further configured to generate a plurality of syndrome bits based on the plurality of data bits and the plurality of parity bits, wherein a state of the plurality of syndrome bits determines if there is a correctable error.

5. The apparatus of claim 4, wherein the ECC circuit comprises an alias logic circuit which, when enabled by the MEC setting, is configured to determine if the state of the plurality of syndrome bits indicates no error, an error in one of the plurality of data bits, or an error in one of the plurality of parity bits and if it does not, change the state of the syndrome.

6. The apparatus of claim 5, wherein the ECC circuit comprises an error locator circuit configured to change a state of one of the subset of the plurality of data bits based on the changed syndrome.

7. The apparatus of claim 1, wherein the subset of the plurality of data bits is in a portion of the plurality of data bits which is selected by a column plane select bit of a column address.

8. An apparatus comprising:
a logic tree configured to generate a plurality of syndrome bits based on a plurality of data bits and a plurality of parity bits as part of a read operation;
an alias logic circuit configured to change a state of the plurality of syndrome bits based on a module error correction setting and a value of the plurality of syndrome bits, wherein the changed plurality of syndrome bits indicate an error in a subset of the plurality of data bits; and
an error correction circuit configured to correct the plurality of data bits based on the plurality of syndrome bits or the changed plurality of syndrome bits.

9. The apparatus of claim 8, wherein the alias logic circuit is configured to change the plurality of syndrome bits if the state of the plurality of syndrome bits has a non-zero state which does not indicate one of the plurality of parity bits or one of the plurality of data bits and the module error correction setting is enabled.

10. The apparatus of claim 8, further comprising an input/output circuit configured to provide a selected portion of the corrected plurality of parity bits based on a column plane select bit, wherein the alias logic circuit is configured to change the plurality of syndrome bits so that the changed plurality of syndrome bits indicate the error in a subset of the plurality of data bits which is part of the selected portion.

11. The apparatus of claim 8, further comprising a mode register configured to store the module error correction setting, wherein the module error correction setting is set based on the behavior of a module error correction circuit of a controller coupled to the apparatus.

12. The apparatus of claim 8, wherein the syndrome bits include a first portion which specifies a data terminal and a second portion which specifies a burst bit, wherein the alias logic circuit is configured to change the second portion.

13. A method comprising:
reading a plurality of data bits and a plurality of parity bits from a memory device on a module;
generating a plurality of syndrome bits based on the plurality of data bits and the plurality of parity bits;
determining if the plurality of syndrome bits indicates an uncorrectable error; and
aliasing one of a subset of the plurality of data bits if the plurality of syndrome bits indicate an uncorrectable error.

14. The method of claim 13, further comprising:
determining if the plurality of syndrome bits indicates a correctable error; and
correcting the error in the plurality of data bits.

15. The method of claim 13, further comprising determining the uncorrectable error based on a non-zero syndrome state which is not associated with one of the plurality of data bits or one of the plurality of parity bits.

16. The method of claim 13, further comprising aliasing a bit in a specified range of burst bits, a specified data terminal, or combinations thereof.

17. The method of claim 13, further comprising enabling the aliasing of the one of the subset of the plurality of data bits based on a module error correction setting.

18. The method of claim 17, further comprising setting the module error correction setting based on an error correction scheme of a controller coupled to the module.

19. The method of claim 13, further comprising:
changing the plurality of syndrome bits if the plurality of syndrome bits indicates an uncorrectable error; and
aliasing the one of the subset of the plurality of data bits with an error correction circuit based on the changed plurality of syndrome bits.

20. The method of claim 19, further comprising changing a portion of the plurality of syndrome bits which indicates a burst bit location.
